(19) United States
(12) Patent Application Publication
(10) Pub. No.: US 2013/0086509 A1
(43) Pub. Date: Apr. 4, 2013

(54) ALTERNATIVE QUERY SUGGESTIONS BY DROPPING QUERY TERMS

(71) Applicants: ASHWIN SATYANARAYANA, SAMMAMISH, WA (US); TABREEZ GOVANI, BELLEVUE, WA (US); SAMIR SHIRAZ PRADHAN, BELLEVUE, WA (US); GIRIDHAR KUMARAN, BOTHELL, WA (US); XIN FU, SANTA CLARA, CA (US); FENG PAN, REDMOND, WA (US); NITIN AGRAWAL, REDMOND, WA (US)

(72) Inventors: ASHWIN SATYANARAYANA, SAMMAMISH, WA (US); TABREEZ GOVANI, BELLEVUE, WA (US); SAMIR SHIRAZ PRADHAN, BELLEVUE, WA (US); GIRIDHAR KUMARAN, BOTHELL, WA (US); XIN FU, SANTA CLARA, CA (US); FENG PAN, REDMOND, WA (US); NITIN AGRAWAL, REDMOND, WA (US)

(73) Assignee: MICROSOFT CORPORATION, REDMOND, WA (US)

(21) Appl. No.: 13/248,261

(22) Filed: Sep. 29, 2011

(51) Int. Cl. G06F 17/30; G06F 3/048

(52) U.S. Cl. 715/781; 707/759; 707/E17.141; 707/E17.137

(57) ABSTRACT

Computer-readable media, computer systems, and computing devices method of facilitating presentation of alternative query suggestions. The method includes referencing an initial query having a plurality of terms. A term(s) to remove from the initial query is identified, for example, based at least on a number of times the term(s) occur in previous queries. The initial query is modified by removing the term(s) from the initial query. Thereafter, the modified query is used to identify an alternative query suggestion(s) that includes at least one term that matches at least one term of the modified query.

### BACKGROUND

Search systems often provide query suggestions as a user inputs a portion of a user query into a search box. In many cases, query suggestions expand or auto-complete a query being entered thereby providing a user with additional characters and/or terms to suggest a more complete user query. Such query suggestions enhance a user's search experience by providing query suggestions that may be relevant or related to the intent of the user and, as such, result in search results relevant to the user. In some instances, however, a user might input a query, or portion thereof, for which very few, if any, query suggestions are available. For example, a user might input a very specific query that has rarely been previously searched. As such, a limited amount of query suggestions are provided to the user. As a result, search results provided to a user may not be content desired by the user resulting in a poor user experience.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

According to embodiments of the invention, alternative query suggestions are provided to a user. In this regard, as a user inputs a search query, the user is provided with query suggestions other than auto-complete query suggestions. Such alternative query suggestions are based on an initial query, such as a query input by a user into a search box, that is modified by removing insignificant or frequently used terms. The modified query can be utilized to identify alternative query suggestions, for example, by matching terms within the modified query to queries within a query log.

### BRIEF DESCRIPTION OF THE DRAWINGS

Embodiments of the invention are described in detail below with reference to the attached drawing figures, wherein:

FIG. 1 is a block diagram of an exemplary computing device suitable for implementing embodiments of the invention;

FIG. 2 is a block diagram of an exemplary network environment suitable for use in implementing embodiments of the invention;

FIG. 3 provides an exemplary illustration of facilitating presentation of an alternative query suggestion, in accordance with embodiments of the invention;

FIG. 4 provides a first graphical display of an alternative query suggestion, in accordance with embodiments of the invention;

FIG. 5 provides a second graphical display of an alternative query suggestion, in accordance with embodiments of the invention;

FIG. 6 is a flow diagram depicting a first illustrative method for facilitating presentation of alternative query suggestions, according to embodiments of the invention;

FIG. 7 is a flow diagram depicting a second illustrative method of facilitating presentation of alternative query suggestions, in accordance with embodiments of the invention; and

FIG. 8 is a flow diagram depicting a third illustrative method of facilitating presentation of alternative query suggestions according to embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention described herein include computer-readable media having computer-executable instructions for performing a method of facilitating presentation of alternative query suggestions. The method includes referencing an initial query having a plurality of terms. A term(s) to remove from the initial query is identified based at least on a number of times the term(s) occurs in previous queries. The initial query is modified by removing the term(s) from the initial query. The modified query is utilized to identify an alternative query suggestion(s), wherein the alternative query suggestion(s) comprises at least one term that matches at least one term of the modified query.

In a second illustrative embodiment, a graphical user interface embodied on one or more computer-readable media and executable on a computer is provided. The graphical user interface includes a first display area configured for displaying at least a portion of a search query. The graphical interface also includes a second display area adjacent to the first display area. The second display area is configured for displaying an auto-complete query suggestion and an alternative query suggestion. The alternative query suggestion is generated based on one or more terms removed from the at least the portion of the search query input into the first display area.

In a third illustrative embodiment, computer-executable instructions cause a computing device to perform a method of facilitating presentation of alternative query suggestions. The method includes referencing a search query input by a user into a search box, the search query comprising a plurality of terms. A specificity score for each of the plurality of terms of the search query is referenced. A first term and a second term to remove from the search query are identified based on a comparison of the specificity scores with a specificity predetermined threshold. The second term is identified to retain based on a comparison of a ngram score associated with the second term with a ngram predetermined threshold. The search query is modified by removing the first term from the search query and retaining the second term. The modified search query and a query log of previously submitted search queries are used to identify an alternative query suggestion that has one or more terms that match one or more terms of the modified query.

Various aspects of embodiments of the invention may be described in the general context of computer program products that include computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including dedicated servers, general-purpose computers, laptops, more specialty computing devices, and the like. The invention may also be practiced in distributed computing environments where tasks are performed by remote-processing devices that are linked through a communications network.

Computer-readable media include both volatile and nonvolatile media, removable and nonremovable media, and contemplate media readable by a database, a processor, and various other networked computing devices. By way of example, and not limitation, computer-readable media include media implemented in any method or technology for storing information. Examples of stored information include computer-executable instructions, data structures, program modules, and other data representations. Media examples include, but are not limited to RAM, ROM, EEPROM, flash memory and other memory technology, CD-ROM, digital versatile discs (DVD), holographic media and other optical disc storage, magnetic cassettes, magnetic tape, magnetic disk storage, and other magnetic storage devices. These technologies can store data momentarily, temporarily, or permanently.

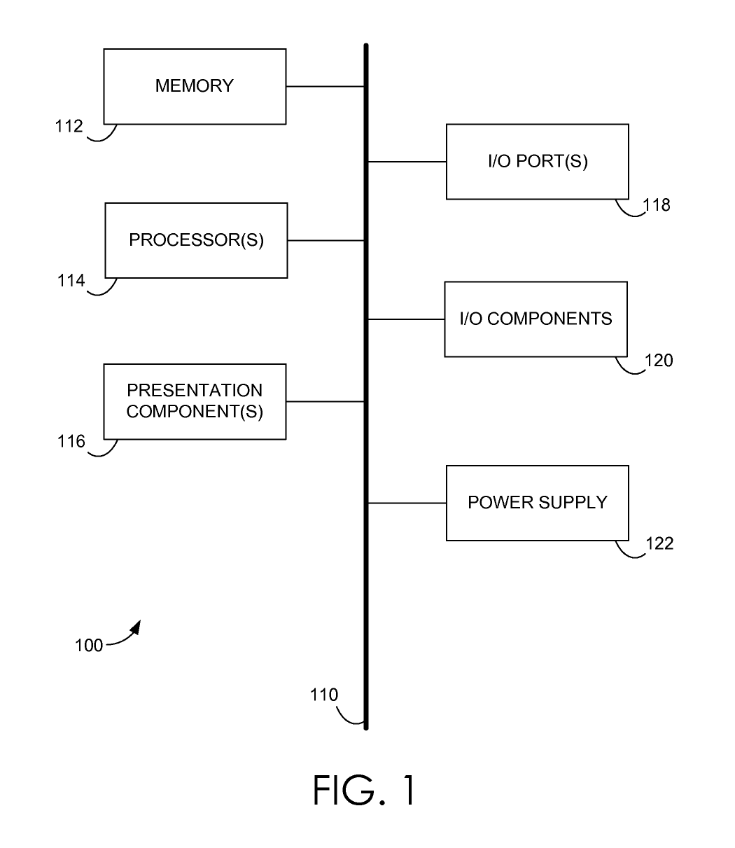

An exemplary operating environment in which various aspects of the present invention may be implemented is described below in order to provide a general context for various aspects of the present invention. Referring initially to FIG. 1, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The computing device 100 includes a bus 110 that directly or indirectly couples the following devices: a memory 112, one or more processors 114, one or more presentation components 116, input/output (I/O) ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The memory 112 includes computer-executable instructions (not shown) stored in volatile and/or nonvolatile memory. The memory may be removable, nonremovable, or a combination thereof. Exemplary hardware devices include solid-state memory, hard drives, optical-disc drives, etc. The computing device 100 includes one or more processors 114 coupled with a system bus 110 that read data from various entities such as the memory 112 or I/O components 120. In an embodiment, the one or more processors 114 execute the computer-executable instructions to perform various tasks and methods defined by the computer-executable instructions. The presentation component(s) 116 are coupled to the system bus 110 and present data indications to a user or other device. Exemplary presentation components 116 include a display device, speaker, printing component, and the like.

The I/O ports 118 allow computing device 100 to be logically coupled to other devices including the I/O components 120, some of which may be built in. Illustrative components include a microphone, joystick, game pad, satellite dish, scanner, printer, wireless device, keyboard, pen, voice input device, touch-input device, touch-screen device, interactive display device, or a mouse. The I/O components 120 can also include communication connections that can facilitate communicatively connecting the computing device 100 to remote devices such as, for example, other computing devices, servers, routers, and the like.

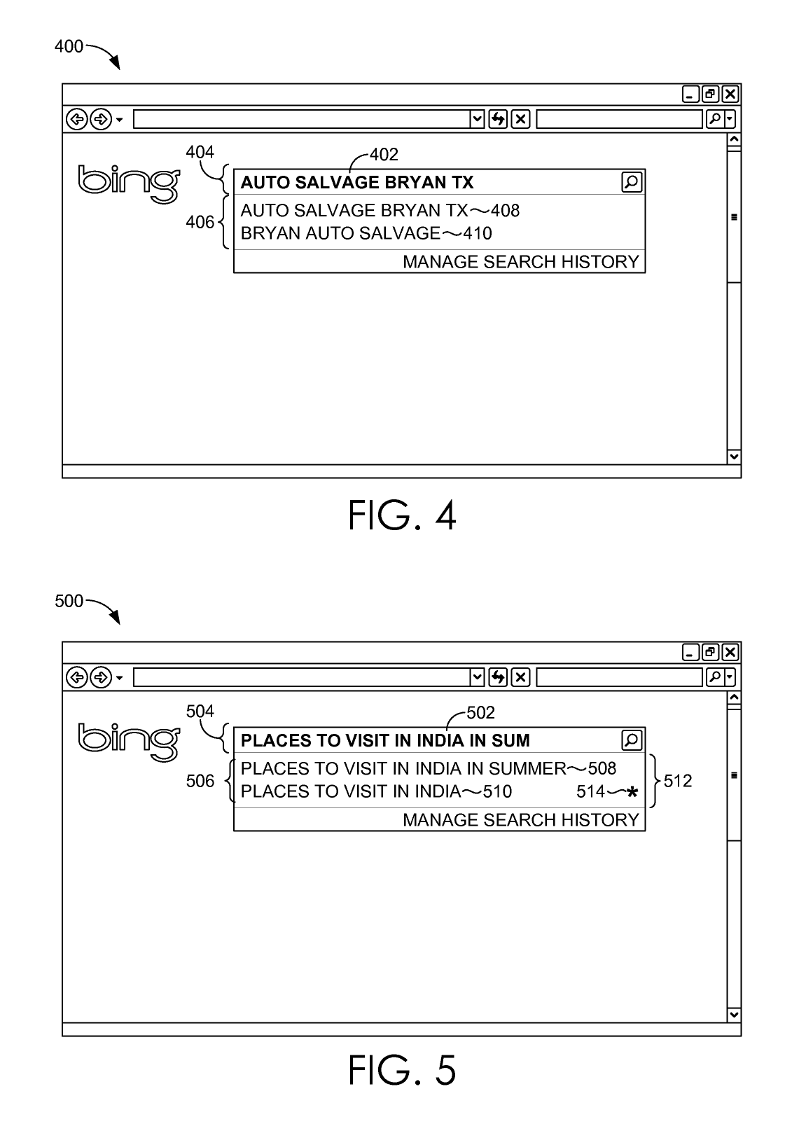

Embodiments of the present invention are directed to providing alternative query suggestions. A query suggestion, as used herein, refers to a query that is suggested to a user based on the query input, or partially input, by a user. Generally, a query suggestion is presented to a user as a user inputs a search query, for example, into a search box on a webpage (e.g., a search page). In embodiments, one or more query suggestions can be displayed to a user via a drop box descending from the search box or in any other position or placement within the webpage. By way of example and with reference to FIG. 4, query suggestion box 406 includes a set of query suggestions.

In some embodiments, a query suggestion is an auto-suggest query (also referred to as a auto-complete suggestion or auto-complete query). An auto-suggest query may be based on previously-submitted user queries identified from a query log, which correspond to the character sequence submitted as part of a user query. As such, an auto-complete query suggestion may provide additional characters and/or terms that complete at least a portion of a user query. For example, a query suggestion for the user query “aut” may be “autotrader,” adding the character “otrader” in the query suggestion. In another example, a query suggestion for the user query “auto s” may be “auto salavage,” adding the characters/terms “alavage” to the submitted query.

An alternative query suggestion refers to a query suggestion that is alternative or additional to other query suggestions provided to a user, such as auto-suggest queries. In this regard, embodiments of the present invention describe aspects of generating and providing alternative query suggestions. Such alternative query suggestions can be presented to a user in response to a query, or partial query, input to a search box. In one embodiment, one or more alternative query suggestions are solely provided to a user. That is, other query suggestions, such as auto-suggest queries, are not provided to a user. Such might be the case when auto-suggest queries do not exist for a particular query or partial query entered by a user. In other embodiments, one or more alternative query suggestions are provided to a user in combination with other query suggestions, such as auto-complete suggestions. For instance, alternative query suggestions can be presented in a separate region from the other query suggestions, juxtaposed or adjacent to other query suggestions, integrated with other query suggestions, etc.

The term “query” refers to any type of request containing one or more search terms (e.g., words, acronyms, etc.) that can be submitted to a search engine (or multiple search engines) for identifying search results based on the search term(s) contained in the query. An input query refers to any portion of a query that has been input into a search box by a user. For example, a portion of a user query may include any number of characters and/or terms, such as the query “aut” being a portion for the query for “autotrader.” A query or input query may include any number of characters and/or terms, whether complete or incomplete, such as a user query including two terms and a portion of a third term.

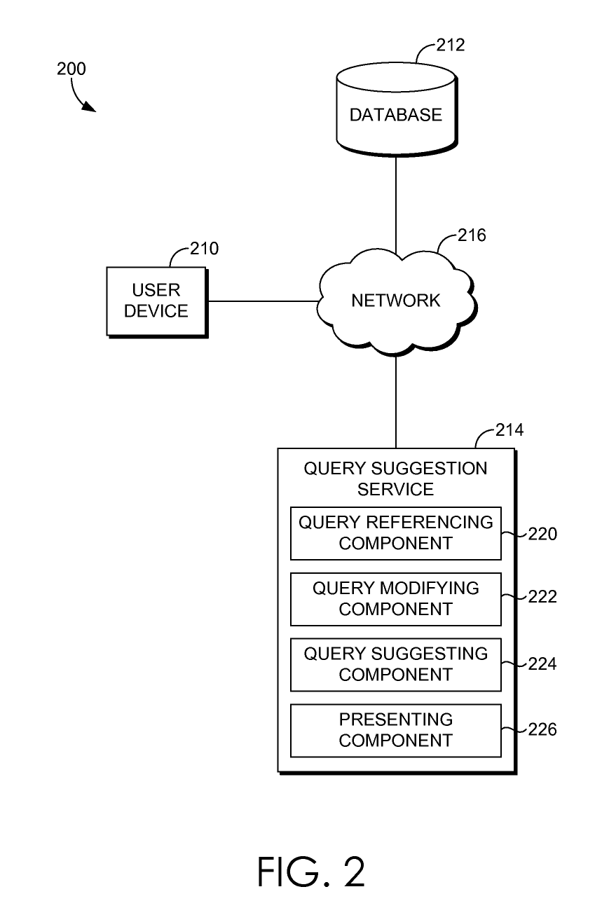

Turning now to FIG. 2, a block diagram of an exemplary network environment 200 suitable for use in implementing embodiments of the invention is shown. The network environment 200 includes a user device 210, a database 212, and a query suggestion service 214. The user device 210, the database 212, and the query suggestion service 214 communicate through a network 216, which may include any number of networks such as, for example, a local area network (LAN), a wide area network (WAN), the Internet, a cellular network, a peer-to-peer (P2P) network, a mobile network, or a combination of networks. The network environment 200 shown in FIG. 2 is an example of one suitable network environment and is not intended to suggest any limitation as to the scope of use or functionality of embodiments of the inventions disclosed throughout this document. Neither should the exemplary network environment 200 be interpreted as having any dependency or requirement related to any single component or combination of components illustrated therein. For example, the user device 210 may be in communication with the query suggestion service 214 via a mobile network or the Internet, and the query suggestion service 214 may be in communication with database 212 via a local area network. Further, although the environment 200 is illustrated with a network, one or more of the components may directly communicate with one another, for example, via HDMI (high-definition multimedia interface), DVI (digital visual interface), etc.

The user device 210 can be any kind of computing device capable of allowing a user to submit a search query, for example, to the query suggestion service 214 and to receive, in response to the input query, one or more query suggestions. For example, in an embodiment, the user device 210 can be a computing device such as computing device 100, as described above with reference to FIG. 1. In embodiments, the user device 210 can be a personal computer (PC), a laptop computer, a workstation, a mobile computing device, a PDA, a cell phone, or the like.

In an embodiment, the user device 210 is separate and distinct from the database 212 and/or the query suggestion service 214 illustrated in FIG. 2. In another embodiment, the user device 210 is integrated with the database 212 and/or query suggestion service 214. For clarity of explanation, we will describe embodiments in which the user device 210, the database 212, and the query suggestion service 214, are separate, while understanding that this may not be the case in various configurations contemplated within the present invention.

The database 212 of FIG. 2 is configured to store various types of information used by the query suggestion service 214 and/or user device 210. In embodiments, the query suggestion service 214 uses information with the database 212 to determine alternative query suggestions. Such a determination can be based on at least a portion of a user query entered by a user. The type of information stored in database 212 may include, for example, queries that have been previously issued or submitted to a search engine or server, such as query suggestion service 214. In embodiments, at least a portion of the queries may be stored in a query log, histogram, or corpus such that the query log may be accessed to identify previously submitted queries. In embodiments, information stored in database 212 may be used to determine one or more alternative query suggestions. For example, query suggestion service may determine alternative query suggestions based on information stored in database 212, including, for example, query logs, specificity scores, and/or ngram scores, as described more fully below.

With continued reference to FIG. 2, the user device 210 communicates with the query suggestion service 214 to facilitate providing alternative query suggestions. In embodiments, for example, a user utilizes the user device 210 to enter a query, or a portion thereof. For instance, in some embodiments, the network 216 might be the Internet, and the user device 210 interacts with the query suggestion service 214 to obtain alternative query suggestions. In other embodiments, for example, the network 216 might be an enterprise network associated with a company. In these embodiments, the user device 210 interacts with the query suggestion service 214 to obtain alternative query suggestions using various nodes within the enterprise network. It should be apparent to those having skill in the relevant arts that any number of other implementation scenarios may be possible as well.

The query suggestion service 214 provides alternative query suggestions. In embodiments, the query suggestion service 214 includes a query referencing component 220, a query modifying component 222, a query suggesting component 224, and a presenting component 226. According to embodiments of the invention, the query suggestion service 214 can include any number of other components not illustrated. In some embodiments, one or more of the illustrated components 220, 222, 224, and 226 can be integrated into a single component or can be divided into a number of different components. Components 220, 222, 224, and 226 can be implemented on any number of machines and can be integrated, as desired, with any number of other functionalities or services.

The query referencing component 220 is generally configured to reference initial queries. An initial query can be used to generate or identify an alternative query suggestion(s). In this regard, an initial query is utilized as a basis or initial point for providing alternative query suggestions.

As can be appreciated, an initial query can be any query or query suggestion that can be used to dynamically identify an alternative query suggestion. By way of example only, an initial query can be an input query. As previously mentioned, an input query refers to any portion of a query that has been entered or input into a search box. Such an input query can be obtained, received, retrieved, or otherwise referenced by the query suggestion service 214, or a portion thereof, upon input by a user (e.g., a character input by a user via a search box). An input query (i.e., search request) can be input or entered by a user via the user device 210. Input queries received from a user can include search queries that were manually or verbally input by the user or other search queries received by the query suggestion service 214 that were somehow approved or entered by the user. As can be appreciated, an input query can be the portion entered into a search box prior to a user selecting to search for related content (i.e., the user has not yet selected the search icon).

Alternatively or additionally, an initial query may be an auto-suggest query. Such an auto-suggest query can be obtained, received, retrieved, or otherwise referenced by the query suggestion service 214, or a portion thereof, for example, from query suggestion service 214 or a service(s). In this regard, the query referencing component 220 can communicate with another service(s) to obtain auto-suggest queries associated with a query, or portion thereof, input by a user. For instance, auto-suggest queries might be retrieved or received from a service (not shown) to reference an auto-suggest query(s) to be provided as a query suggestion in response to a query, or portion thereof, input by a user.

Although initial queries are described herein as input queries and/or auto-suggest queries, other forms of queries or query suggestions or contemplated to be within the scope of embodiments of the present invention. In this regard, any form of query suggestion can be used as an initial query to derive an alternative query suggestion.

In embodiments, the query referencing component 220 can dynamically reference input queries. Accordingly, an input query can be referenced upon entering or modifying any portion of the query (e.g., an addition or deletion of a character). Similarly, an auto-suggest query can be referenced upon an auto-suggest service (not shown) identifying or determining an auto-suggest query (e.g., prior to, simultaneous with, or after presenting the auto-suggest query to the user, for example, via an query suggestion display).

The query modifying component 222 is generally configured to modify initial queries. Initial queries are modified or reformulated so that alternative query suggestions can be identified. In some cases, prior to modifying initial queries, a determination may be made as to whether to provide alternative query suggestions based on the initial query. In this way, alternative query suggestions may not be provided for each input query and/or auto-complete query. In one example, alternative query suggestions may be provided for input queries that are tail queries. A tail query, as used herein, refers to a query for which there is a limited number of auto-suggest queries. In this regard, tail queries are queries that occur very infrequently in query logs or histograms (e.g., generally long queries, detailed queries, etc.). For example, assume a user enters a detailed or specific query into a search box. Further assume that the number of auto-suggest queries that exist for that particular query is below a predetermined threshold (e.g., five, three, one, etc.). In such a case, a determination can be made that alternative query suggestions are to be provided to the user. In another example, a determination of whether to provide an alternative query suggestion(s) can be based on, for instance, a type of initial query (e.g., input query, auto-select query), a user preference, or the like.

In other cases, a determination as to whether to provide alternative query suggestions is not required. For example, each input query and/or auto-suggest query associated with an input query can be used to identify alternative query suggestions.

The query modifying component 222 can modify an initial query by removing various terms within the initial query. That is, insignificant or non-specific terms within an initial query can be removed to result in a more succinct and directed modified query. In one embodiment, specificity scores associated with terms are utilized to identify terms to remove from a query. A specificity score indicates an extent of specificity of a particular term. Specificity scores can be calculated or determined using any method, calculation, formula, lookup index, etc. In embodiments, a specificity score uses or is based at least in part on a number of times or frequency that a particular term occurs in previous queries. In some cases, a specificity score is a value (e.g., number) that indicates a frequency of a particular term within previous queries relative to other terms. In this regard, the frequency of a particular term within previous queries can be compared to frequency of other terms within previous queries or frequency of the particular term occurring with other terms. In one implementation, a specificity score S(t) for a term t within an initial query is calculated using the following calculation:

$$S ( t ) = {\sum }_{i}^{ } P ( \frac{i}{t} ) log \frac{P ( i \text{/} t )}{P ( i )} \qquad Equation 1$$

wherein f(i) is the number of queries in which term i occurs, p(i) is the frequency with which term i appears across all queries (i.e., f(i)/N), and N is the total number of queries in the corpus. g(i) is the number of queries in which both terms i and t occur. q(i) is the probability of i's occurrence conditioned on t (i.e., g(i)/N_t), wherein N_t is the number of queries containing t in the corpus. The specificity of t is then defined as the Kullback-Leibler divergence of q from p (i.e., D_{KL}(q∥P)).

As such, previously received queries are analyzed to identify which terms frequently occur with a large number of other terms. For instance, the term “free” may occur with “free camera,” “free milkshake,” “free cd,” etc. In the above calculation, “free” is the term t for which a specificity score is calculated while i is every other term in the corpus other than t. Because “free” occurs with many other terms, the term “free” may result in a low specificity score and deemed unimportant or insignificant.

In embodiments, a specificity score is calculated for each term within an initial query. Specificity scores may be dynamically calculated or calculated offline and stored in a database, such as database 212 of FIG. 2. Accordingly, upon obtaining an initial query, a database or index can be accessed to identify (e.g., look up) specificity scores for various terms within the initial query.

More specific, or less-common, terms can be provided with a higher or greater specificity score that indicates a stronger term or otherwise more specific term. For example, a specificity score for a term with great specificity that is determined using equation 1 discussed above generally results in a higher specificity score (e.g., value). In other cases, a more specific, or less-common, term can be provided with a lower specificity score that indicates a stronger term or otherwise more specific term. For example, a specificity score based solely on frequency of a term within previous queries generally results in terms used less frequently having a lower specificity score.

Specificity scores can be analyzed to determine which, if any, terms to remove from an initial query. In some cases, specificity scores below or above a predetermined threshold are removed or deleted from the initial query. A predetermined threshold can be any threshold that indicates a maximum or minimum value. In other cases, specificity scores can be compared to one another to determine which, if any, terms to remove from an initial query. For instance, two terms with the lowest or greatest specificity score may be removed.

To prevent removing terms that are part of a phrase that may be significant to the initial query, the query modifying component 222 can detect and retain phrases recognized as such. In embodiments, phrases to be retained can be identified using ngram scores. An ngram refers to a subsequence of n items from a given sequence (e.g., bigram (two sequential terms), trigram (three sequential terms), etc.). A ngram score can be calculated or identified in any number of ways. In some cases, a ngram score can be obtained by mining query logs, such as query logs stored in database 212, to identify frequencies or scores for various ngrams. For instance, a ngram score might be a frequency or a number of times that a particular ngram occurred in previously submitted queries. In embodiments, a ngram score can be identified for each ngram within an initial query or a particular set of ngrams within an initial query (e.g., bigrams, bigrams and trigrams, a specific ngram, etc.). Ngram scores may be dynamically calculated or calculated offline and stored in a database, such as database 212 of FIG. 2. Accordingly, upon obtaining an initial query, a database or index can be accessed to identify (e.g., look up) ngram scores for various ngrams or phrases within the initial query.

Ngram scores can be analyzed to determine which, if any, phrases to retain within the initial query. In some cases, ngram scores below or above a predetermined threshold are maintained within the initial query. In other cases, ngram scores can be compared to one another to determine which, if any, phrases to retain. For instance, an ngram(s) with the lowest or greatest ngram score may be retained. In some cases, more common ngrams (phrases) are associated with a higher or greater ngram score. For example, an ngram score based on frequency of the ngram within previous queries generally results ngrams used more frequently having a greater ngram score. In other cases, more common ngrams may be associated with a lower ngram score.

By way of example only, assume that a user inputs a query “information about tom green.” The phrase “tom green” would be detected as a bigram with a high ngram score (e.g., high frequency) and thereby retained in the modified query even though the word “green” may have a low specificity score resulting in a term that would otherwise be removed from the initial query.

The query modifying component 222 can reformulate the initial query to generate a modified query in accordance with the specificity scores and ngram scores. In this regard, any terms that are not part of a phrase to be retained are removed from the initial query to result in a modified or reformulated query. In some cases, terms suggested for removal may be evaluated in light of the ngram data to determine whether such terms should be retained as part of a phrase. In other cases, phrases or ngrams to be retained can be initially recognized and, thereafter, specificity analysis can be performed to determine if any of the remaining terms are to be removed from the initial query.

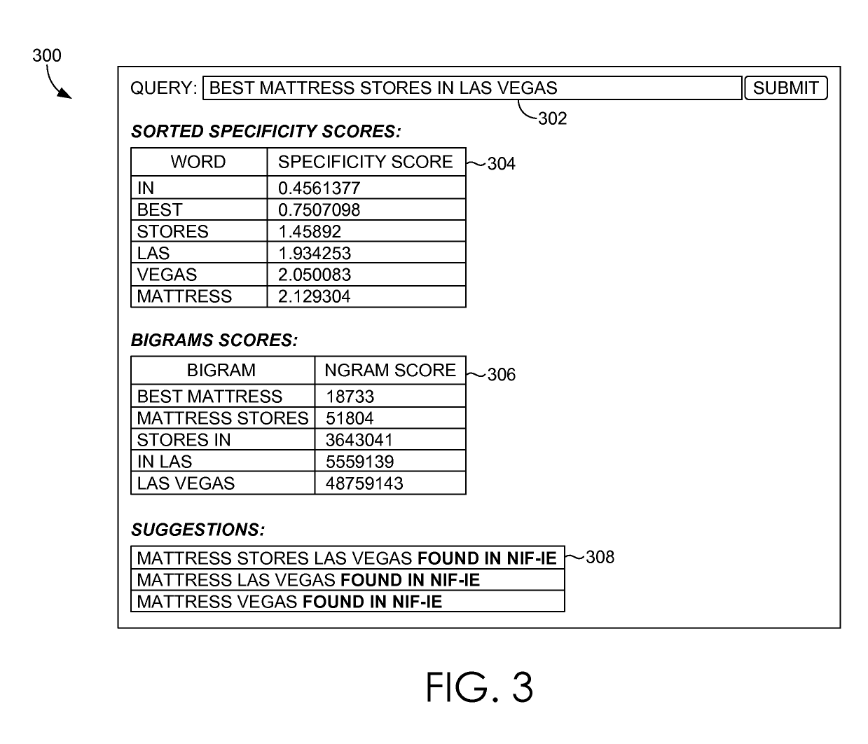

By way of example only and with reference to FIG. 3, assume that a user types an input query 302 of “best mattress stores in las vegas.” As shown in table 304, a specificity score is referenced for each word within the input query 302. Such a specificity score can be, for example, dynamically calculated or dynamically referenced using a lookup index. As can be recognized, more specific terms, such as “stores,” “las,” “vegas,” and “mattress,” have higher specificity scores of 1.45892, 1.934253, 2.050083, and 2.129304, respectively. By comparison, less specific terms, such as “in” and “best,” have lower specificity scores of 0.4561377 and 0.7507098, respectively. As illustrated in table 306, ngram scores for various bigrams within the input query 302 are also referenced. Such ngram scores can be, for example, dynamically calculated or dynamically referenced using a lookup index. Although not illustrated, ngram scores can be calculated and analyzed for any number of terms within a phrase (bigram, trigram, etc.). The most common phrase “las vegas” has the greatest ngram score of 48759143 providing a strong indication that such a common phrase, or portion thereof, should not be removed. Accordingly, the resulting modified query is “mattress stores las vegas” with the “best” and “in” terms being removed from the query based on a lower specificity score (e.g., under a threshold such as “1”).

The query suggesting component 224 is generally configured to provide alternative query suggestions. The query suggesting component 224 can use the modified query to attain alternative query suggestions. In embodiments, a modified query is mapped to existing queries in a query log, query histogram, existing query suggestions log, or the like. In this regard, one or more of the terms within the modified query can be utilized (e.g., looked up) within a query log or log of previous query suggestions to identify if such a term(s)/phrase exists in the log. As can be appreciated, in some embodiments, any number of the remaining terms can be searched for in such query logs. For example, a modified query may be “mattress stores las vegas” but alternative query suggestions may additionally include “mattress las vegas” and “mattress vegas.” Additionally or alternatively, in some embodiments, an alternative query suggestion can include terms within a modified query that are in any order. In this regard, assume a modified query is “mattress stores las vegas.” In such a case, alternative query suggestions may include “las vegas mattress” and “vegas mattress.”

By way of example and with reference to FIG. 3, assume a modified query is identified as “mattress stores las vegas” with “best” and “in” removed from the initial query for being very common or insignificant terms. Queries within a query log or a query suggestion log can be analyzed, looked up, or referenced to identify any previous queries or query suggestions that include that set of terms or a subset of those terms. As illustrated in table 308, several previous queries or query suggestions include at least a portion of those terms of the modified query including query suggestion “mattress stores las vegas,” “mattress las vegas,” and “mattress vegas.”

Returning to FIG. 2, the presenting component 226 is configured to present alternative query suggestions. In one embodiment, alternative query suggestions are presented by displaying such suggestions in association with a query, or portion thereof, input by a user. As previously described, such alternative query suggestions can be provided separate from other query suggestions, such as auto-suggest queries, or integrated therewith. The alternative query suggestions can be displayed adjacent to (e.g., a drop query suggestion box) or nearby the corresponding input query. In another embodiment, alternative query suggestions are presented by communicating such data to another computing device. For example, alternative query suggestions may be communicated to a search engine such that the search engine can incorporate the data into the search results page to be transmitted to the user device. By way of further example, such data may be communicated to the user device for display to the user, via a display screen of the user device.

By way of example only, FIGS. 4-5 illustrate displays of a graphical user interface for providing alternative query suggestions, according to embodiments of the present invention. Such display views can be viewed, for example, via a display screen of a user device, such as user device 210. As can be appreciated, a user may interact with a display screen using well known input components, such as, for example, a mouse, joystick, stylus, touch screen, keyboard, or the like.

FIG. 4 illustrates an exemplary search engine website 400 presented to a user. Assume that a user enters user query 402 into the search box 404. As illustrated in FIG. 4, a set of query suggestions is displayed within query suggestion box 406 in response to the user search query 402 being input. Such query suggestions in query suggestion box 406 includes an auto-complete query suggestion 408 and an alternative query suggestion 410.

FIG. 5 illustrates an exemplary search engine website 500 presented to a user. Assume that a user enters user query 502 into the search box 504. As illustrated in FIG. 5, a set of query suggestions 506 is displayed in a query suggestion display area 512 in response to the user search query 502 being input. Such query suggestions 506 include an auto-complete query suggestion 508 and an alternative query suggestion 510. As can be appreciated, alternative query suggestion 510 can be based on, for example, the user search query 502 and/or the auto-complete query suggestion 508. Although not illustrated, alternative query suggestions can be displayed in any location within the search results screen (e.g., separate and distinct from auto-complete query suggestions).

In some cases, an alternative suggestion indicator may be displayed in association with a corresponding alternative query suggestion to provide an indication that the particular query suggestion is an alternative query suggestion. In this regard, an alternative suggestion indicator may provide an indication that a specific query suggestion is based on modifications made to the initial query (e.g., query input by user). An example of an alternative suggestion indicator 514 is provided in FIG. 5. Such an alternative suggestion indicator can take on any form and, in some cases, may be a variation to the actual alternative query suggestion (e.g., a format or color change to a particular query suggestion, such as displaying an alternative query suggestion in an italic font or a bold font).

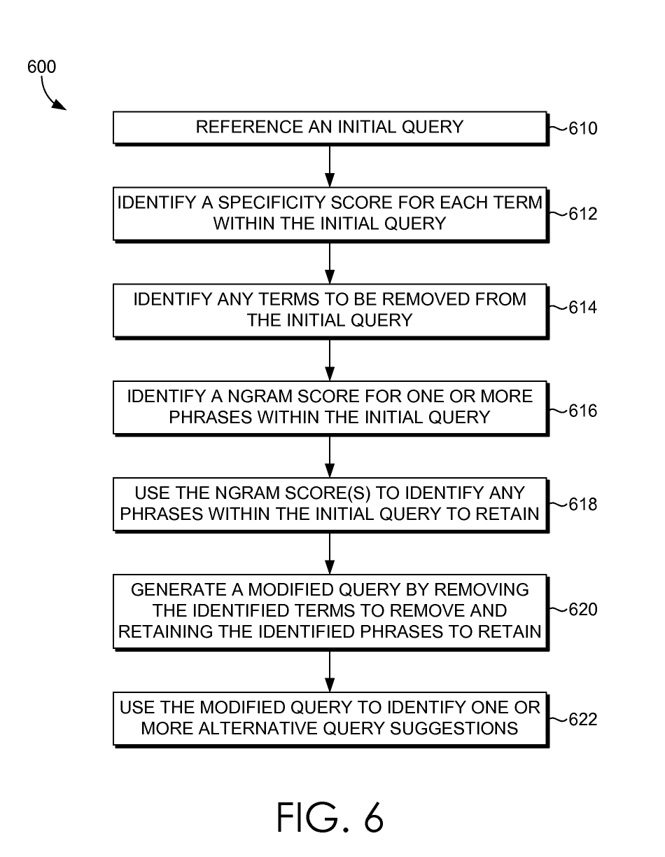

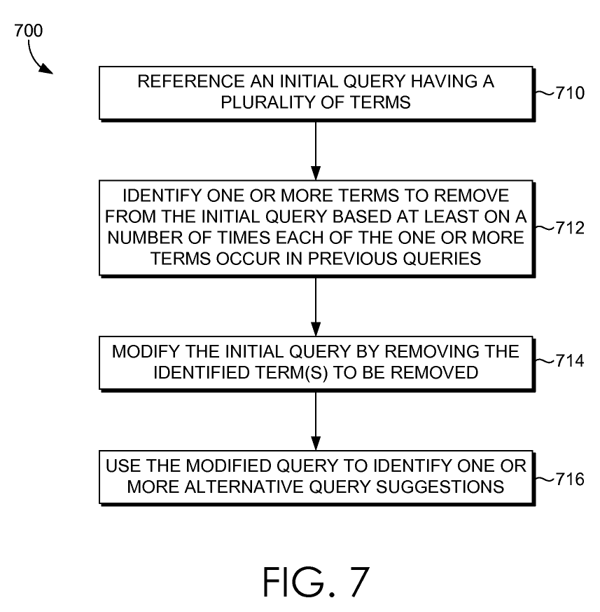

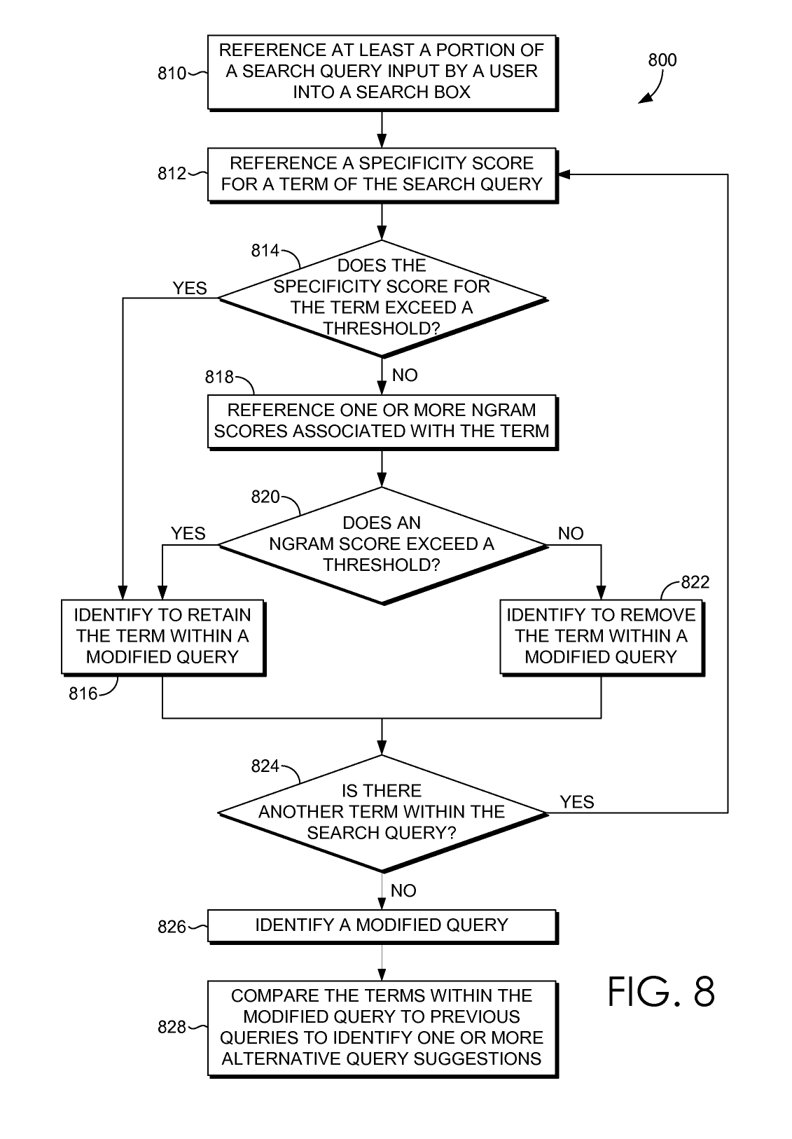

To recapitulate, embodiments of the invention include systems, machines, media, methods, techniques, processes and options for providing alternative query suggestions. Such alternative query suggestions can be displayed in proximity to a corresponding query input by a user. Turning to FIG. 6, a flow diagram is illustrated that shows an exemplary method 600 for providing alternative query suggestions, according to embodiments of the present invention. In some embodiments, aspects of embodiments of the illustrative method 600 can be stored on computer-readable media as computer-executable instructions, which are executed by a processor in a computing device, thereby causing the computing device to implement aspects of the method 600. The same is of course true with the illustrative methods 700 and 800 depicted in FIGS. 7 and 8, respectively, or any other embodiment, variation, or combination of these methods.

Initially, at block 610, an initial query is referenced. Such an initial query might be input by a user using a user device, such as user device 210 of FIG. 2, or be a query suggestion, such as an auto-complete query suggestion identified based on a user query input by a user. At block 612, a specificity score is identified for each term within the initial query. Such a specificity score, for example, can be referenced using a lookup index having pre-calculated specificity scores. Any terms to be removed from the initial query are identified, as indicated at block 614. In embodiments, specificity scores can be compared to one another or to a threshold to determine which, if any, terms to remove from an initial query. At block 616, an ngram score is identified for one or more phrases within the initial query. Any phrases to be retained are identified based on the ngram scores, as indicated at block 618. For example, ngram scores can be compared to one another or to a threshold to determine which, if any, phrases to retain. At block 620, a modified query is generated by removing any identified terms to remove and retaining any identified phrases to retain. The modified query is utilized to identify one or more alternative query suggestions. This is indicated at block 622. The modified query may be used to find comparable queries within a query log of previously submitted queries. In this regard, one or more previously submitted queries that at least include the terms within the modified query may be deemed an appropriate or acceptable alternative query suggestion. As can be appreciated, method 600 can be repeated for other initial queries or upon modification of an initial query.

Turning now to FIG. 7, a flow chart depicts an illustrative method 700 of providing alternative query suggestions. Initially, at block 710, an initial query having a plurality of terms is referenced. At block 712, one or more terms to remove from the initial query are identified based at least on a number of times each of the one or more terms occur in previous queries. The initial query is modified, as indicated at block 714 by removing the one or more terms from the initial query. At block 716, the modified query is used to identify one or more alternative query suggestions. Such alternative query suggestions can be identified based on at least one term that matches at least one term of the modified query. The alternative query suggestions can be looked-up or referenced using a query log or suggested query log.

With reference to FIG. 8, another flow chart depicts an illustrative method 800 of providing alternative query suggestions. With initial reference to block 810, at least a portion of a search query input by a user into a search box is referenced. The search query includes a plurality of terms. At block 812, a specificity score for a term within the search query is referenced. At block 814, it is determined if the specificity score exceeds a predetermined threshold. If so, at block 816, the term is identified for retention within a modified query. If not, at block 818, one or more ngram scores associated with the term are referenced. Thereafter, at block 820, it is determined if an ngram score exceeds a threshold. If so, the term is identified for retention within a modified query, as indicated at block 816. If not, the term is identified for removal within a modified query. This is indicated at block 822.

At block 824, it is determined if there is another term within the search query to analyze. If there is another term within the search query to analyze, the method returns to block 812 to analyze that term. If there is not another term within the search query to analyze, at block 826, a modified query is identified or generated. Such a modified query retains terms identified at block 816 and removes terms identified at block 822. At block 828, the terms within the modified query are compared to previous queries to identify one or more alternative query suggestions. In this regard, the modified search query and a query log of previously submitted search queries are utilized to identify an alternative query suggestion that has one or more terms that match one or more terms of the modified query. Although FIG. 8 describes specificity scores and ngram scores exceeding a threshold, as can be appreciated, in other embodiments, the method may require a specificity score and/or ngram score to be below a particular specificity threshold or ngram threshold, respectively.

Various embodiments of the invention have been described to be illustrative rather than restrictive. Alternative embodiments will become apparent from time to time without departing from the scope of embodiments of the inventions. It will be understood that certain features and sub-combinations are of utility and may be employed without reference to other features and sub-combinations. This is contemplated by and is within the scope of the claims.

The invention claimed is:

1. One or more computer-readable storage media having embodied thereon computer-executable instructions that, when executed by a processor in a computing device, cause the computing device to perform a method of facilitating presentation of alternative query suggestions, the method comprising:
referencing an initial query having a plurality of terms;
identifying one or more terms to remove from the initial query based at least on a number of times the one or more terms occur in previous queries;
modifying the initial query by removing the one or more terms from the initial query; and
using the modified query to identify one or more alternative query suggestions, wherein each of the one or more alternative query suggestions comprise at least one term that matches at least one term of the modified query.

2. The media of claim 1, wherein the initial query comprises at least a portion of a search query input by a user into a search box.

3. The media of claim 1, wherein the initial query comprises an auto-complete query suggestion associated with at least a portion of a search query input by a user into a search box.

4. The media of claim 1, wherein the one or more terms are removed from the initial query when the number of times the one or more terms occur in previous queries exceeds a predetermined threshold.

5. The media of claim 1 further comprising identifying a specificity score for each of the plurality of terms, wherein the number of times the one or more terms occur in previous queries is used to identify the specificity score for each of the plurality of terms.

6. The media of claim 5 further comprising utilizing the specificity score for each of the plurality of terms to identify the one or more terms from the initial query to remove.

7. The media of claim 6, wherein the one or more terms are identified to be removed from the initial query when the specificity score is below a predetermined threshold.

8. The media of claim 1 further comprising referencing a query log of previously submitted queries.

9. The media of claim 8, wherein the one or more alternative query suggestions are identified by identifying one or more queries within the query log having at least one term that matches the at least one term of the modified query.

10. The media of claim 1 further comprising presenting the one or more alternative query suggestions in association with the initial query.

11. A graphical user interface embodied on one or more computer-readable media and executable on a computer, the graphical user interface comprising:
a first display area configured for displaying at least a portion of a search query; and
a second display area adjacent to the first display area, the second display area displaying at least one auto-complete query suggestion and at least one alternative query suggestion, wherein the at least one alternative query suggestion is generated based on one or more terms removed from the at least the portion of the search query input into the first display area.

12. The graphical user interface of claim 11, wherein the at least one auto-complete query suggestion and the at least one alternative query suggestion are modified when the at least a portion of the search query is modified.

13. The graphical user interface of claim 11, wherein the at least one auto-complete query suggestion and the at least one alternative query suggestion are presented within a drop box descending from the first display area.

14. The graphical user interface of claim 11, wherein the at least one auto-complete query suggestion and the at least one alternative query suggestion are integrated with one another.

15. The graphical user interface of claim 11 further comprising a third display area adjacent to the second display area that displays an alternative suggestion indicator, the alternative suggestion indicator providing an indication that the corresponding alternative query suggestion is based on modification of the at least a portion of the search query.

16. One or more computer-readable storage media having embodied thereon computer-executable instructions that, when executed by a processor in a computing device, cause the computing device to perform a method of facilitating presentation of alternative query suggestions, the method comprising:
referencing at least a portion of a search query input by a user into a search box, the at least the portion of the search query comprising a plurality of terms;
referencing a specificity score for each of the plurality of terms of the search query;
identifying a first term and a second term to remove from the search query based on a comparison of the specificity scores with a specificity predetermined threshold;
identifying to retain the second term based on a comparison of a ngram score associated with the second term with a ngram predetermined threshold;
modifying the search query by removing the first term from the search query and retaining the second term; and
utilizing the modified search query and a query log of previously submitted search queries to identify an alternative query suggestion that has one or more terms that match one or more terms of the modified query.

18. The media of claim 17, wherein the first term and the second term are identified to be removed when the corresponding specificity scores do not exceed the specificity predetermined threshold.

19. The media of claim 17, wherein the second term is identified to be retained when the corresponding ngram score exceeds the ngram predetermined threshold.

20. The media of claim 17 further comprising searching the query log to identify one or more previously submitted search queries having one or more terms that correspond with the one or more terms of the modified query.
